(19) United States
(12) Patent Application Publication
(10) Pub. No.: US 2025/0297377 A1
(43) Pub. Date: Sep. 25, 2025

(54) SOLID OXIDE ELECTROLYSIS UNIT

(71) Applicant: Topsoe A/S, Kgs. Lyngby (DK)

(72) Inventors: Mogens Andersen, Copenhagen Ø (DK); Anders Helbo Hansen, Espergærde (DK)

(73) Assignee: Topsoe A/S, Kgs. Lyngby (DK)

(21) Appl. No.: 18/863,969

(22) PCT Filed: May 11, 2023
(86) PCT No.: PCT/EP2023/062595

§ 371 Date: Nov. 7, 2024

(30) Foreign Application Priority Data
May 18, 2022 (EP) 22173998.0

(51) Int. Cl. C25B 9/70; C25B 1/02; C25B 1/23; C25B 9/65; C25B 13/07

(52) U.S. Cl. CPC C25B 9/70; C25B 1/02; C25B 1/23; C25B 9/65; C25B 13/07

(57) ABSTRACT

The present invention relates to a Solid Oxide Electrolysis unit for industrial hydrogen. carbon monoxide or syngas production comprising at least two Solid Oxide Electrolysis cores that each comprise several Solid Oxide Electrolysis stacks of Solid Oxide Electrolysis cells. a power supply to manage electrical power to the Solid Oxide Electrolysis cores and piping connected to the Solid Oxide Electrolysis cores. According to the invention. the Solid Oxide Electrolysis unit comprises a power supply module. which comprises a transformer and at least one power supply unit. and a piping module. which comprises piping headers and fluidic connections going to and from the Solid Oxide Electrolysis cores. wherein the power supply module and the piping module are arranged adjacent to each other and the Solid Oxide Electrolysis cores are arranged above the power supply module and/or the piping module.

The present invention relates to a Solid Oxide Electrolysis unit for industrial hydrogen, carbon monoxide or syngas production, which is hydrogen and carbon monoxide combined.

A Solid Oxide Electrolysis unit according to the preamble of independent claim 1 comprises at least two Solid Oxide Electrolysis cores that each comprise several Solid Oxide Electrolysis stacks of Solid Oxide Electrolysis cells, a power supply to manage electrical power to the Solid Oxide Electrolysis cores and piping connected to the Solid Oxide Electrolysis cores.

A Solid Oxide Electrolysis unit according to the preamble of claim 1 is known from US 2021/0156039 A1. The known Solid Oxide Electrolysis unit comprises three Solid Oxide Electrolysis cores that are arranged next to each other, wherein a power supply module is attached to the side surface of every Solid Oxide Electrolysis core. The Solid Oxide Electrolysis cores are supplied with water from a common water supply module, which is spatially separated from the Solid Oxide Electrolysis cores and arranged on a hub that is surrounding the area on which the Solid Oxide Electrolysis cores are placed. The known Solid Oxide Electrolysis unit further comprises a switchgear module that provides power to the three power supply modules and a common heat exchanger module that provides cooling/heat to the Solid Oxide Electrolysis cores, wherein these modules are also arranged at the hub. By using compact modules for certain components of the Solid Oxide Electrolysis unit these components can be preassembled else where and an exchange of defect modules is facilitated.

However, further improvements are needed to improve the hydrogen, carbon monoxide or syngas turnover per required installation area and the construction and maintenance efficiency so that Solid Oxide Electrolysis units are more competitive for industrial hydrogen, carbon monoxide or syngas production.

Therefore, the object of the present invention is to provide an improved Solid Oxide Electrolysis unit.

A solution of the object according to the invention exists if the Solid Oxide Electrolysis unit comprises a power supply module, which comprises a transformer and at least one power supply unit, and a piping module, which comprises piping headers and fluidic connections going to and from the Solid Oxide Electrolysis cores, wherein the power supply module and the piping module are arranged adjacent to each other and the Solid Oxide Electrolysis cores are arranged above the power supply module and/or the piping module.

By arranging the main electrical components inside a power supply module and the components for fluidic transfer inside a piping module, these modules can be designed compactly and therefore decrease the footprint of the Solid Oxide Electrolysis unit. According to the invention, the footprint of the Solid Oxide Electrolysis unit can be further decreased, by arranging the Solid Oxide Electrolysis cores above the power supply module and/or the piping module. The Solid Oxide Electrolysis cores may be mounted or de-mounted individually in both cold and warm condition. The Solid Oxide Electrolysis cores including their frames may be lifted and handled both by crane by mounted lifting eyes and by fork-lifter by means of suitable holes in the bottom frame. In addition, this way, the upper area of the piping module and/or power supply module that is not occupied by the Solid Oxide Electrolysis cores can be used to reach for the Solid Oxide Electrolysis cores during maintenance. Further, the electrical connections between the power supply unit and the Solid Oxide Electrolysis cores and the fluidic connections between the headers and the Solid Oxide Electrolysis cores can be kept short, which simplifies the construction and increases the efficiency of the Solid Oxide Electrolysis unit. According to the invention, the electrical connections are part of the power supply module and the fluidic connections are part of the piping module.

Preferably, the electrical connections and the fluidic connections are only arranged at or attached to the bottom sides of the Solid Oxide Electrolysis cores. This way the upper side of the Solid Oxide Electrolysis cores are free from cables and piping, which facilitates maintenance of the Solid Oxide Electrolysis cores and also facilitates commissioning.

Advantageous embodiments of the present invention are the subject of the dependent claims.

According to a preferred embodiment of the present invention, the Solid Oxide Electrolysis cores are arranged above the piping module. This arrangement is particularly preferred, since the fluidic connections can be further simplified, which is advantageous for commissioning. The electrical connections are more flexible in form. Hence, it is easier to connect them to the Solid Oxide Electrolysis cores even if the Solid Oxide Electrolysis cores are not arranged above the power supply module. Preferably, the electrical connections are only arranged at or attached to an upper side of the at least one power supply unit. This keeps the electrical connections short, which increases power transmission efficiency.

Preferably, the Solid Oxide Electrolysis cores are also arranged above the power supply module. This way the footprint of the Solid Oxide Electrolysis unit can be used even more efficiently and the fluidic connections as well as the electrical connections can still be kept short and simple.

According to another preferred embodiment of the present invention, the power supply module comprises a power supply skid frame and the piping module comprises a piping skid frame. In a different embodiment of the present invention, the power supply module comprises a transformer skid frame, in which the transformer is arranged, and a power supply unit skid frame, in which the at least one power supply unit is arranged and the piping module comprises a piping skid frame, wherein preferably the transformer skid frame is placed adjacent to the power supply unit skid frame. By using skid frames for the power supply module and the piping module, these modules can be transported more easily and the other components of the modules can be accessed better during commissioning and maintenance. In case the power supply module comprises a separate transformer skid frame and power supply unit skid frame, the accessibility to the transformer and the at least one power supply unit can be further improved. Besides the exchange of a part of the power supply module is also facilitated.

In a further preferred embodiment, the at least two Solid Oxide Electrolysis cores are part of a core module that comprises a cores skid frame. This way, the Solid Oxide Electrolysis cores can be shipped together and their positioning to each other can be fixed. This simplifies the commissioning of the Solid Oxide Electrolysis unit.

In an alternative embodiment, the at least two Solid Oxide Electrolysis cores are each arranged on separate core frames that preferably each comprise junction boxes for electrical and instrument cable connections and pipe connections. By arranging each of the Solid Oxide Electrolysis cores on a single core frame, this assembly is more compact and can be transported individually more easily. In addition, a single core frame with Solid Oxide Electrolysis core can be replaced more easily. Preferably, the Solid Oxide Electrolysis unit comprises at least one intermediate module that supports at least two Solid Oxide Electrolysis cores and their core frames and comprises intermediate cables and pipes that connect the Solid Electrolysis cores and the power supply module and piping module. One intermediate module preferably supports two Solid Oxide Electrolysis cores on their respective core frames. By using intermediate modules that connect the power supply module and piping module to several Solid Oxide Electrolysis cores, the number of necessary connection points for the piping module and power supply module can be reduced. Further, in case the at least one intermediate module stretches over the power supply module and the piping module, it can be used as additional fixation between the power supply module and the piping module.

In a preferred embodiment of the present invention, the skid frames all have the outer dimensions of a standard 40′ High cube container and preferably same connection points, wherein the skid frames of the modules are fixed to each other. By using these standard dimensions and preferably connection points, the transportation of the respective modules can be further simplified. Further, the respective skid frames can be connected to each other by a known and efficient system, which increases the stability of the Solid Oxide Electrolysis unit. In an alternative embodiment, the transformer skid frame has the outer dimensions of a 20′ High cube container and the power supply unit skid frame and the piping skid frame the outer dimensions of a standard 40′ High cube container and preferably same connection points, wherein the power supply unit skid frame and the piping skid frame are fixed to each other and the transformer skid frame and the power supply unit skid frame are also fixed to each other. This brings the same advantages as the continuous use of standard 40′ high cube container skid frames, whereby the divided power supply module in particular facilitates the connecting of the transformer to the main power grit and at the same time, the power supply unit/s in the power supply unit skid frame can be made even larger.

According to another preferred embodiment of the present invention, the piping module and its piping skid frame are configured such that the transformer and the at least one power supply unit of the power supply unit and preferably the bottom sides of the Solid Oxide Electrolysis cores can be accessed via it. This facilitates commissioning and maintenance work on the components of the power supply module, on the bottom side of the Solid Oxide Electrolysis cores and on the components of the piping module. Preferably, the piping module and its piping skid frame are configured such that central heat exchangers, which are part of each of the Solid Oxide Electrolysis cores, can be lowered down from the cores into the piping skid frame during maintenance of the Solid Oxide Electrolysis cores. This way, the central heat exchangers can be efficiently removed from the Solid Oxide Electrolysis cores for maintenance of the central heat exchangers and/or the Solid Oxide Electrolysis cores.

Preferably, the headers and fluidic connections going to and from the Solid Oxide Electrolysis cores are arranged along longitudinal side areas of the piping skid frame and/or on the bottom of the piping skid frame, such that a central passageway, from which the fluid connections are accessible, is provided through the piping module. This is a preferred and efficient arrangement of the components of the piping module, which allows for the above-mentioned features. Further, the respective headers and fluidic connections are easily accessible from the inside of the piping skid frame, which facilitates work on the piping.

Yet according to another preferred embodiment, an area on top of the power supply skid frame or the power supply unit skid frame is configured as a working platform with grating and hand railing. This way, the area on top of the power supply skid frame can be advantageously used for commissioning and maintenance of the Solid Oxide Electrolysis cores.

According to another preferred embodiment of the present invention, the Solid Oxide Electrolysis unit comprises six Solid Oxide Electrolysis cores and the power supply module comprises two power supply units, wherein each power supply unit supplies three Solid Oxide Electrolysis cores with power. Especially when using one cores module with the cores skid frame with the dimensions of the 40′ high cube container, six Solid Oxide Electrolysis cores at the above-mentioned size result in a high hydrogen, carbon monoxide or syngas output per footprint area of the Solid Oxide Electrolysis unit. As the possible power supply per power supply unit is limited, it might be necessary to include a second power supply unit into the power supply module. Depending on the size of the Solid Oxide Electrolysis cores, other numbers of Solid Oxide Electrolysis cores per cores module might also be beneficial.

Yet according to another preferred embodiment of the present invention, the Solid Oxide Electrolysis unit comprises two of said piping modules and at least one of said power supply module, preferable two of said power supply units, wherein at least two of said Solid Oxide Electrolysis cores, preferably six of said Solid Oxide Electrolysis cores, are arranged above each of the two of said piping modules. By using two piping modules with Solid Oxide Electrolysis cores arranged above, the overall output of the Solid Oxide Electrolysis unit can be increased. Since the Solid Oxide Electrolysis cores must be easily accessible for maintenance, several arrangements of piping modules, power supply module/s and Solid Oxide Electrolysis cores are favorable. The power supply module or the two power supply modules are arranged side-by-side in between the two piping modules with Solid Oxide Electrolysis cores on top of both piping modules or the two piping modules with Solid Oxide Electrolysis cores on top of both piping modules are arranged side-by-side adjacent to each other and in between two power supply modules.

Preferably, the two of said piping modules are arranged adjacent to each other, wherein the two of said piping modules are identical and rotated 180° with respect to each other.

In another preferred embodiment of the invention, at least one core frame is arranged above the piping module and above the power supply module each. Preferably, six core frames are each arranged above the piping module and above the power supply module. This allows the footprint of the Solid Oxide Electrolysis unit to be utilized even better.

In a preferred embodiment, the at least one intermediate module supports two Solid Oxide Electrolysis cores, wherein the at least one intermediate module is arranged above the piping module and the power supply module, such that one of two Solid Oxide Electrolysis cores is arranged above the piping module and the other one of two Solid Oxide Electrolysis cores is arranged above the power supply module. This allows the piping connections and electrical connections between the intermediate module and the piping module and the power supply module to be kept short and the intermediate module can be attached to both modules, which in turn improves the stability of the entire Solid Oxide Electrolysis unit.

In a further preferred embodiment, the Solid Oxide Electrolysis unit comprises a central walkway between the at least one core frame above the piping module and the at least one core frame above the power supply module, which preferably is arranged on top of the at least one intermediate module and which is further preferably fitted with at least one ladder for access. The walkway allows easy access to the Solid Oxide Electrolysis cores, the core frames and the junction boxes, which simplifies the connection and maintenance of the Solid Oxide Electrolysis cores.

In a further preferred embodiment, the Solid Oxide Electrolysis unit is configured such that the Solid Oxide Electrolysis cores and/or their upper housing can be lifted up by an external crane for maintenance and replacement of the Solid Oxide Electrolysis cores or stacks. This way the Solid Oxide Electrolysis cores can be serviced and exchanged very efficiently. Since the Solid Oxide Electrolysis cores are above the piping module and the power supply module it is much easier for a crane to remove individual Solid Oxide Electrolysis cores or their upper housings without damaging other components of the Solid Oxide Electrolysis unit.

In a particularly preferred embodiment of the present invention, the piping module/s and the power supply module/s are configured such that they can be preassembled before their installation onsite, wherein preferably the core module/s or the core frame/s with the Solid Oxide Electrolysis cores in combination with the intermediate module/s is/are also configured such that it/they can be preassembled before installation onsite. By using preassembled modules/assemblies, the cost efficiency of the production and the commissioning of the Solid Oxide Electrolysis unit can be improved. Preferably, the modules are configured such that only interconnections between the several modules and to external components have to be put in place during commissioning. This again facilitates commissioning.

In a further preferred embodiment, the headers in the piping module run an entire length of the piping module and are terminated at both ends with flanges or blind flanges. In this way, the headers of the piping module can be attached to external components like the water, steam and/or carbon dioxide supply and the hydrogen, carbon monoxide or syngas storage unit on both ends.

This way, standardized piping modules can be used and their orientation onsite is more flexible.

In a particularly preferred embodiment, each one of the Solid Oxide Electrolysis cores has a capacity of at least 0.3 MW, preferably at least 0.5 MW. By using this size of Solid Oxide Electrolysis cores, the output of the Solid Oxide Electrolysis unit is suitable for industrial hydrogen, carbon monoxide or syngas production. At the same time, the amount of time necessary for the maintenance of individual Solid Oxide Electrolysis cores is still efficient. Further, maintenance on individual Solid Oxide Electrolysis cores can be performed, while the other Solid Oxide Electrolysis cores of the Solid Oxide Electrolysis unit are running.

The invention further relates to a method of commissioning a Solid Oxide Electrolysis unit according to claims 1 to 24, wherein the method comprises a step of arranging the power supply skid frame/s of the power supply module/s and the piping skid frame/s of the piping module/s adjacent to each other and fixating them to each other, a step of arranging Solid Oxide Electrolysis cores or cores module/s on top of the piping module/s, a step of connecting the electrical connections of the power supply module/s and the fluidic connections of the piping module/s to the Solid Oxide Electrolysis cores and a step of connecting the transformer of the power supply module/s to an external power supply and the headers of the piping module/s to external components regarding water, steam and/or carbon dioxide supply and hydrogen, carbon monoxide or syngas storage.

In a preferred embodiment of the method of commissioning a Solid Oxide Electrolysis unit according to claims 1 to 24, the method further comprises a step of fixating at least one intermediate module on top of a piping module and power supply module, wherein the step of connecting the electrical connections of the power supply module/s and the fluidic connections of the piping module/s to the Solid Oxide Electrolysis cores comprises a first part of connecting the electrical connections of the power supply module and the fluidic connections of the piping module to the at least one intermediate module and a second part of connecting the electrical connections and the fluidic connections of the intermediate module/s to the Solid Oxide Electrolysis cores.

The invention also relates to a method of servicing Solid Oxide Electrolysis cores of a Solid Oxide Electrolysis unit according to claims 1 to 15, wherein the method comprises a step of lifting a upper housing of one of the Solid Oxide Electrolysis cores from the Solid Oxide Electrolysis core with an external crane, preferably a step of lowering the central heat exchanger of the one of the Solid Oxide Electrolysis cores into the piping module, a step of servicing the Solid Oxide Electrolysis stacks or Solid Oxide Electrolysis cells of the one Solid Oxide Electrolysis core and a step of reassembling the one of the Solid Oxide Electrolysis cores.

Embodiments of the present invention shall be explained in more detail hereinafter with reference to the drawings.

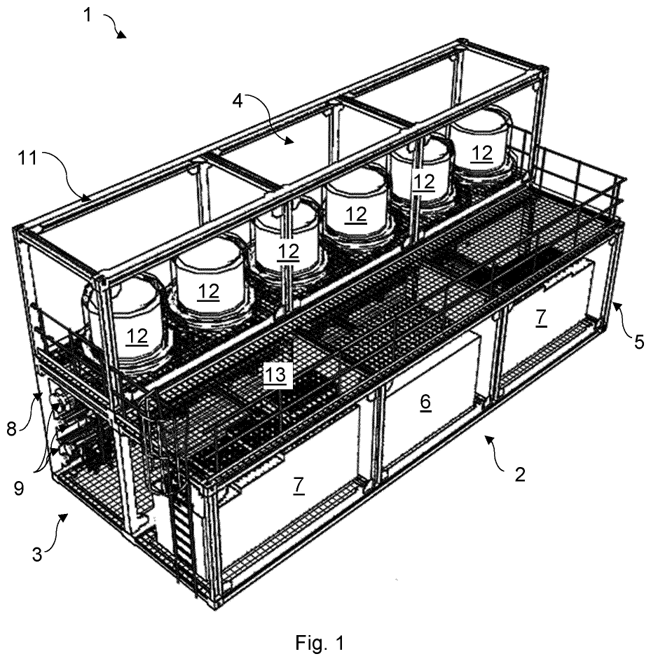

FIG. 1 shows a perspective view of a Solid Oxide Electrolysis unit according to a first embodiment of the present invention with a power supply module, a piping module and a cores module,

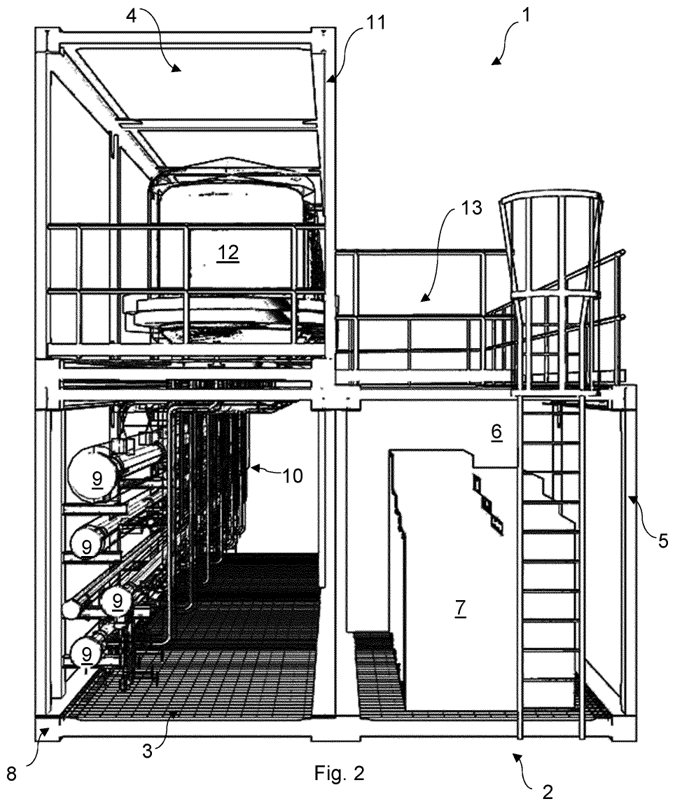

FIG. 2 shows a view on the longitudinal ends of the first embodiment of the Solid Oxide Electrolysis unit shown in FIG. 1,

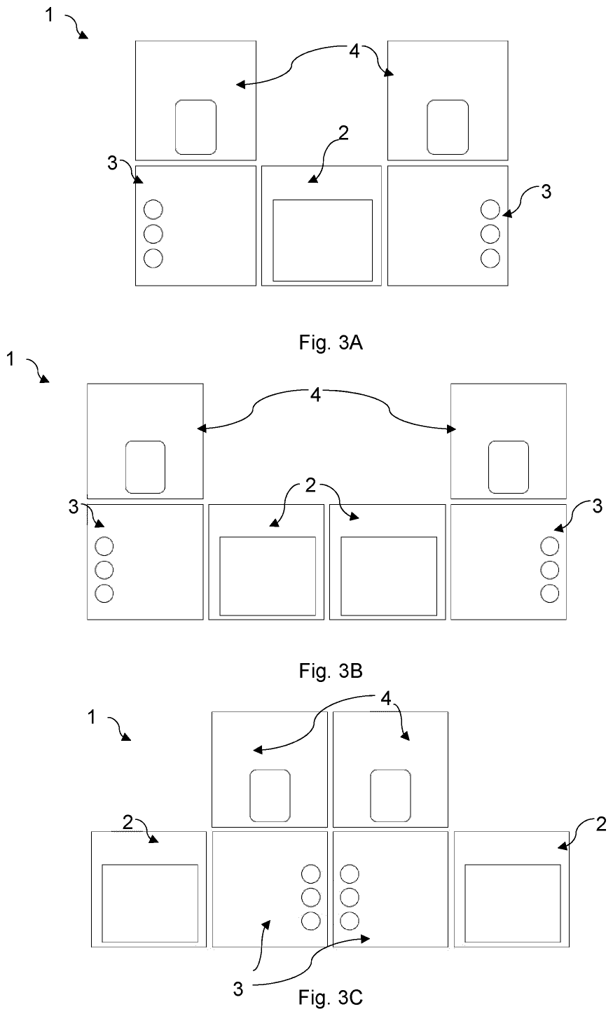

FIG. 3A, B, C shows sketches of views on the longitudinal ends of other embodiments of the Solid Oxide Electrolysis unit according to the invention,

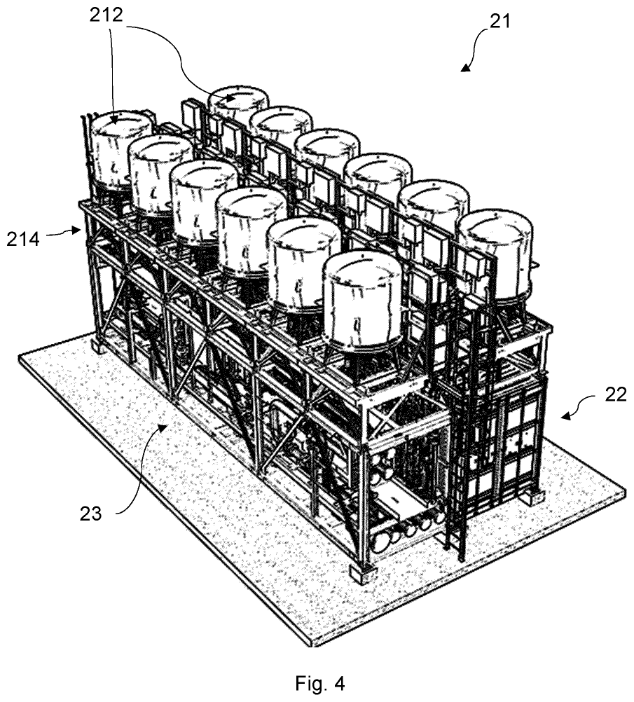

FIG. 4 shows a perspective view of a Solid Oxide Electrolysis unit according to another embodiment of the present invention with a power supply module, a piping module, six intermediate modules and twelve Solid Oxide Electrolysis cores on core frames,

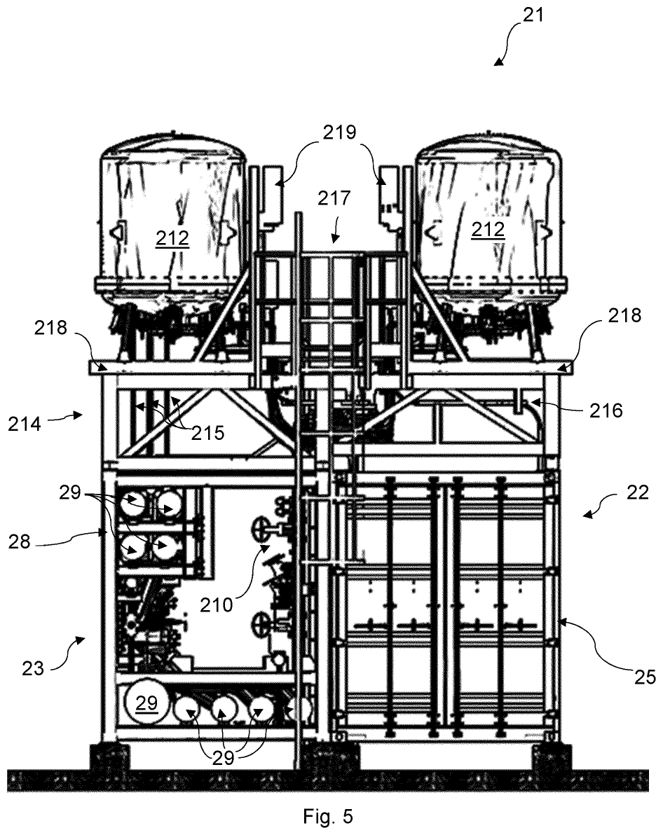

FIG. 5 shows a view on the longitudinal ends of the embodiment of the Solid Oxide Electrolysis unit shown in FIG. 4,

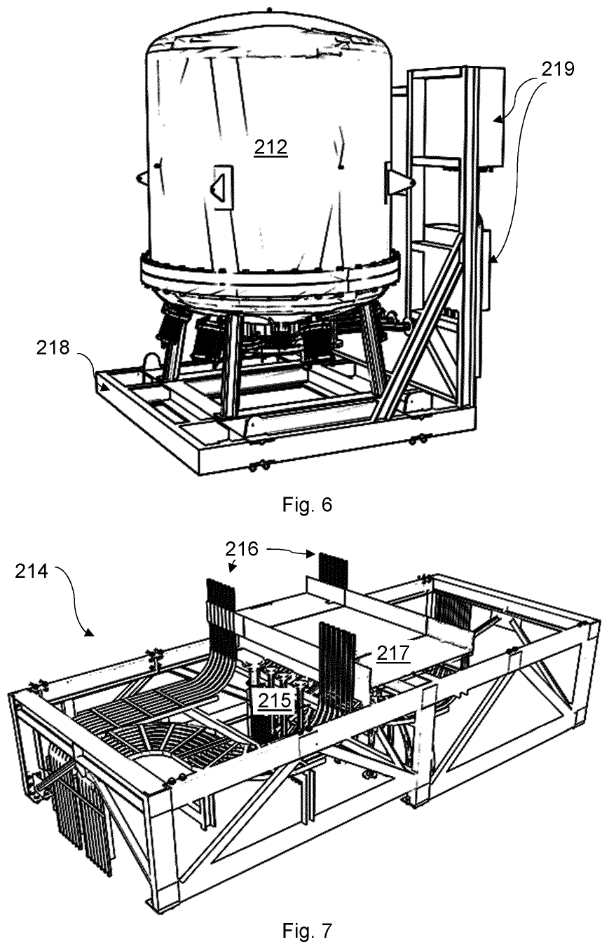

FIG. 6 shows a perspective view of Solid Oxide Electrolysis core on a core frame according to the embodiment shown in FIG. 4, and

FIG. 7 shows a perspective view of intermediate module and a part of the walkway according to the embodiment shown in FIG. 4.

A first embodiment of a Solid Oxide Electrolysis unit 1 according to the present invention is shown in FIGS. 1 and 2, whereas FIG. 1 shows a perspective view of the first embodiment of the Solid Oxide Electrolysis unit 1 and FIG. 2 shows a view onto the longitudinal end of the Solid Oxide Electrolysis unit 1 according to the first embodiment.

Solid Oxide Electrolysis unit 1 comprises a power supply module 2, a piping module 3 and a cores module 4. The power supply module 2 comprises an open power supply skid frame 5 in which a transformer 6 and two power supply units 7 are arranged. The transformer 6 is placed in between the two power supply units 7 to connect them to a not shown external power supply. The piping module 3 comprises an open piping skid frame 8, in which headers 9 and fluidic connections 10 are arranged alongside a longitudinal side surface of the piping skid frame 8. The headers 9 run alongside the entire longitudinal length of the piping skid frame 8 and are terminated at both ends with flanges or blind flanges. This way the headers 9 can be connected to external components like a water, steam and/or carbon dioxide supply and a hydrogen, carbon monoxide or syngas storage on both longitudinal ends of the piping module 3. The cores module 4 comprises an open cores skid frame 11, in which six Solid Oxide Electrolysis cores 12 are arranged adjacent to each other. The Solid Oxide Electrolysis cores 12 comprise several Solid Oxide Electrolysis stacks with a plurality of Solid Oxide Electrolysis cells.

The respective skid frames 5, 8, 11 of the power supply module 2, the piping module 3 and the cores module 4 all have the dimensions of a standard 40′ High cube container and its connecting points. The power supply module 2 is arranged next to the piping module 3, wherein the piping skid frame 8 and the power supply skid frame 5 are attached to each other and wherein the longitudinal side surface of the piping skid frame 8, alongside which the headers 9 and fluidic connections 10 are arranged inside the piping module 3, is distanced from the power supply module 2. This way an access way is created inside the piping module 3 from which the header 9 and fluidic connections 10 from the piping module as well as the power supply units 7 and the transformer 6 can be accessed.

The cores module 4 is arranged above the piping module 3 and its cores skid frame 11 is attached to the piping skid frame 8. The power supply units 7 are connected to the Solid Oxide Electrolysis cores 12 via electrical connections that are not shown, wherein the electrical connections lead from the upper surface of the power supply units 7 to the bottom surfaces of the Solid Oxide Electrolysis cores 12 and wherein three Solid Oxide Electrolysis cores 12 are powered by one of the two power supply units 7. The headers 9 of the piping module 3 are connected to the bottom surfaces of the Solid Oxide Electrolysis cores 12 via the fluidic connections 10. Due to the arrangement of the cores module 4 above the piping module 3 and the power supply module 2 arranged next to the piping module 3, the electrical connections and fluidic connections 10 can be kept very short and can be easily installed. Since the electrical connections and fluidic connections 10 are only attached to the bottom surfaces of the Solid Oxide Electrolysis cores 12, the upper surfaces of the Solid Oxide Electrolysis cores 12 are free of piping and cables. This facilitates the servicing and maintenance of the Solid Oxide Electrolysis cores 12. Further, a working platform 13 with grating and hand railing is placed on top of the power supply module 2. The servicing and maintenance of the Solid Oxide Electrolysis cores 12 can be performed from this working platform 13. During maintenance of the Solid Oxide Electrolysis cores 12, central heat exchangers of the Solid Oxide Electrolysis cores 12 can be lowered down into the access way inside the piping module 3 and upper housings of the Solid Oxide Electrolysis cores 12 can be lifted from the Solid Oxide Electrolysis cores 12 by an external crane (not shown) without the risk of damaging other components of the Solid Oxide Electrolysis unit 1.

As mentioned above, the first embodiment of the Solid Oxide Electrolysis unit 1 shown in FIGS. 1 and 2 comprises six Solid Oxide Electrolysis cores 12. Each of these Solid Oxide Electrolysis cores 12 has a rating of 0.5 MW. This way the Solid Oxide Electrolysis unit 1 has a rating of 3 MW with a compact footprint. Other sizes and numbers of Solid Oxide Electrolysis cores 12 can be located within a cores module 4. However, it is important that the Solid Oxide Electrolysis cores 12 are easily accessible for maintenance and that the dimension of the entire cores module 4 does not become too large.

Therefore, another way to increase the output of the Solid Oxide Electrolysis unit 1 is to add an additional piping module 3, an additional cores module 4 and potentially an additional power supply module 2 to the Solid Oxide Electrolysis unit 1. Preferable arrangements for this are schematically shown in FIGS. 3A, B, C. For these arrangements, it is important that the individual components, especially the Solid Oxide Electrolysis cores 12, remain easily accessible. For example, a crane must still be able to reach the Solid Oxide Electrolysis cores 12 easily. In addition, it is advantageous, if modules 2, 3, 4 that are used twice can be of identical design.

FIG. 3A shows a first arrangement with two piping modules 3, two cores modules 4 and one power supply module 2. The power supply module 2 is arranged in between the two piping modules 2, wherein the piping modules 3 are identical but arranged rotated by 180° about the power supply module 2. This way the access way of both piping modules 3 is arranged towards the power supply module 2. The two cores modules 4 are arranged above the two piping modules 3.

Above the power supply module 2 a working platform 13 can arranged from which the Solid Oxide Electrolysis cores 12 of both cores modules 4 can be accessed easily.

FIG. 3B shows a second arrangement, which is similar to the first arrangement, wherein the Solid Oxide Electrolysis unit 1 comprises two power supply modules 2 instead of one. These two power supply modules 2 are arranged side by side in between the two piping modules 3, wherein the components of each of the power supply modules can be accessed via one of the access way inside on of the piping modules 3. By using two power supply units 2 the size and/or number of the Solid Oxide Electrolysis cores 12 inside the two cores modules 4 above the piping modules 2 can be increased, since the transmittable power of two power supply modules 2 can be higher than of one, if the external dimensions are to remain the same.

FIG. 3C shows a third arrangement with two piping modules 3, two cores modules 4 and two power supply modules 2. In this arrangement, the piping modules 3 are arranged side by side in between the two power supply modules 2 and the two cores modules 4 are arranged on top of the piping modules 3. Again, the two piping modules 3 are arranged rotated by 180° towards each other that the access ways of the two piping modules are directed towards one of the power supply modules 2.

Another embodiment of a Solid Oxide Electrolysis unit 21 according to the present invention is shown in FIGS. 4 and 5, whereas FIG. 4 shows a perspective view of the other embodiment of the Solid Oxide Electrolysis unit 21 and FIG. 5 shows a view onto the longitudinal end of the Solid Oxide Electrolysis unit 21 according to the other embodiment.

Solid Oxide Electrolysis unit 21 comprises a power supply module 22, a piping module 23, six intermediate modules 214 and twelve Solid Oxide Electrolysis cores 212, wherein the Solid Oxide Electrolysis core 212 mounted on a core frame 218 is shown in more detail in FIG. 6 and the intermediate module 214 with a part of the walkway 217 is shown in more detail in FIG. 7. The power supply module 22 comprises a closed power supply skid frame 25 with the dimensions of a standard 40′ High cube container and its connecting points in which a transformer and power supply units are arranged. An closed power supply skid frame 25 may be advantageous to limit the effects of weather on the transformer and power supply units. The piping module 23 comprises an open piping skid frame 28 with the dimensions of a standard 40′ High cube container and its connecting points in which headers 29 and fluidic connections 210 are arranged alongside the longitudinal side surfaces and the bottom of the piping skid frame 28, such that a central passageway, from which the fluid connections 210 are accessible, is provided through the piping module 23. The headers 29 run alongside the entire longitudinal length of the piping skid frame 28 and are terminated at both ends with flanges or blind flanges. This way the headers 28 can be connected to external components like a water, steam and/or carbon dioxide supply and a hydrogen, carbon monoxide or syngas storage on both longitudinal ends of the piping module 23. On top of the power supply module 22 and the piping module 23 six intermediate modules 214 are arranged, which are fixated to the piping skid frame 28 and the power supply skid frame 25. On each intermediate module 214 two Solid Oxide Electrolysis cores 212 are arranged, one above the power supply module 22 and one above the piping module 23.

The power supply module 22 is arranged next to the piping module 23, wherein the piping skid frame 28 and the power supply skid frame 25 are attached to each other. The intermediate modules 214 have such a width that they can be attached to connection points of the piping skid frame 28 and the power supply skid frame 25. Within the intermediate modules 214 are arranged intermediate fluidic connections 215 and intermediate electrical connections 216 that connect the fluidic connections of the piping module 23 and the electrical connections of the power supply module 22 with the respective connections of the two Solid Oxide Electrolysis cores 212, which are arranged on top of the respective intermediate module 214. In between the two Solid Oxide Electrolysis cores 212 a central walkway 217 is installed onto the intermediate modules 214. The walkway 217 extends over the six intermediate modules 214 and thus over the entire length of the Solid Oxide Electrolysis unit 21, wherein two ladders on the respective ends of the walkway 217 lead from the ground to the walkway 217. The walkway 217 can be used for maintenance and commissioning.

The Solid Oxide Electrolysis cores 212 are placed on core frames 218, which are then arranged on top of the respective intermediate module 214. These core frames 218 facilitate the transport of the respective Solid Oxide Electrolysis cores 212 and include junction boxes 219 that can provide preassembled electrical and instrument cable connections between the Solid Oxide Electrolysis cores 212 and itself and can then provide an easy connection to the intermediate electrical connections 216.

### LIST OF REFERENCE SIGNS

1, 21 Solid Oxide Electrolysis unit
2, 22 Power supply module
3, 23 Piping module
4 Cores module
5, 25 Power supply skid frame
6 Transformer
7 Power supply units
8, 28 Piping skid frame
9, 29 Headers
10, 210 Fluidic connections
11 Cores skid frame
12, 212 Solid Oxide Electrolysis cores
13 Working platform
214 Intermediate module
215 Intermediate fluidic connections
216 Intermediate electrical connections
217 Walkway
218 Core frame
219 Junction box

1. Solid Oxide Electrolysis unit for industrial hydrogen, carbon monoxide or syngas production comprising at least two Solid Oxide Electrolysis cores that each comprise several Solid Oxide Electrolysis stacks of Solid Oxide Electrolysis cells, a power supply to manage electrical power to the Solid Oxide Electrolysis cores and piping connected to the Solid Oxide Electrolysis cores, wherein the Solid Oxide Electrolysis unit comprises a power supply module, which comprises a transformer and at least one power supply unit, and a piping module, which comprises piping headers and fluidic connections going to and from the Solid Oxide Electrolysis cores, wherein the power supply module and the piping module are arranged adjacent to each other and the Solid Oxide Electrolysis cores are arranged above the power supply module and/or the piping module.

2. Solid Oxide Electrolysis unit according to claim 1, wherein the Solid Oxide Electrolysis cores are arranged above the piping module.

3. Solid Oxide Electrolysis unit according to claim 2, wherein the Solid Oxide Electrolysis cores are also arranged above the power supply module.

4. Solid Oxide Electrolysis unit according to claim 1, wherein the power supply module comprises a power supply skid frame and the piping module comprises a piping skid frame.

5. Solid Oxide Electrolysis unit according to one of the claim 1, wherein the power supply module comprises a transformer skid frame, in which the transformer is arranged, and a power supply unit skid frame, in which the at least one power supply unit is arranged and the piping module comprises a piping skid frame, wherein preferably the transformer skid frame is placed adjacent to the power supply unit skid frame.

6. Solid Oxide Electrolysis unit according to claim 1, wherein the at least two Solid Oxide Electrolysis cores are part of a core module that comprises a cores skid frame.

7. Solid Oxide Electrolysis unit according to claim 1, wherein the at least two Solid Oxide Electrolysis cores are each arranged on separate core frames that preferably each comprise junction boxes for electrical and instrument cable connections and pipe connections.

8. Solid Oxide Electrolysis unit according to claim 7, wherein the Solid Oxide Electrolysis unit comprises at least one intermediate module that supports at least two Solid Oxide Electrolysis cores and their core frames and comprises intermediate cables and pipes that connect the Solid Electrolysis cores and the power supply module and piping module.

9. Solid Oxide Electrolysis unit according to claim 4, wherein the skid frames all have the outer dimensions of a standard 40′ High cube container and preferably same connection points, wherein the skid frames of the modules are fixed to each other.

10. Solid Oxide Electrolysis unit according to claim 5, wherein the transformer skid frame has the outer dimensions of a 20′ High cube container and the power supply unit skid frame and the piping skid frame the outer dimensions of a standard 40′ High cube container and preferably same connection points, wherein the power supply unit skid frame and the piping skid are fixed to each other and the transformer skid frame and the power supply unit skid frame are also fixed to each other.

11. Solid Oxide Electrolysis unit according to claim 4, wherein the piping module and its piping skid frame are configured such that the transformer and the at least one power supply unit of the power supply unit can be accessed via it.

12. Solid Oxide Electrolysis unit according to claim 4, wherein the piping module and its piping skid frame are configured such that bottom sides of the Solid Oxide Electrolysis cores can be accessed via it, wherein preferably the piping module and its piping skid frame are configured such that central heat exchangers, which are part of each of the Solid Oxide Electrolysis cores, can be lowered down from the cores into the piping skid frame during maintenance of the Solid Oxide Electrolysis cores.

13. Solid Oxide Electrolysis unit according to claim 4, wherein the headers and fluidic connections of the piping module going to and from the Solid Oxide Electrolysis cores are arranged along longitudinal side areas of the piping skid frame and/or on the bottom of the piping skid frame, such that a central passageway, from which the fluid connections are accessible, is provided through the piping module.

14. Solid Oxide Electrolysis unit according to claim 4, wherein an area on top of the power supply skid frame or the power supply unit skid frame is configured as a working platform with grating and hand railing.

15. Solid Oxide Electrolysis unit according to claim 1, wherein the Solid Oxide Electrolysis unit comprises six Solid Oxide Electrolysis cores and the power supply module comprises two power supply units, wherein each power supply unit supplies three Solid Oxide Electrolysis cores with power.

16. Solid Oxide Electrolysis unit according to claim 1, wherein the Solid Oxide Electrolysis unit comprises two of said piping modules and at least one of said power supply module, preferable two of said power supply units, wherein at least two of said Solid Oxide Electrolysis cores, preferably six of said Solid Oxide Electrolysis cores, are arranged above each of the two of said piping modules.

17. Solid Oxide Electrolysis unit according to claim 16, wherein the two of said piping modules are arranged adjacent to each other, wherein the two of said piping modules are identical and rotated 180° with respect to each other.

18. Solid Oxide Electrolysis unit according to claim 7, wherein at least one core frame is arranged above the piping module and above the power supply module each, preferably six core frames are each arranged above the piping module and above the power supply module.

19. Solid Oxide Electrolysis unit according to claim 18, wherein the at least one intermediate module supports two Solid Oxide Electrolysis cores, wherein the at least one intermediate module is arranged above the piping module and the power supply module, such that one of two Solid Oxide Electrolysis cores is arranged above the piping module and the other one of two Solid Oxide Electrolysis cores is arranged above the power supply module.

20. Solid Oxide Electrolysis unit according to claim 18, wherein the Solid Oxide Electrolysis unit comprises a central walkway between the at least one core frame above the piping module and the at least one core frame above the power supply module, which preferably is arranged on top of the at least one intermediate module and which is further preferably fitted with at least one ladder for access.

21. Solid Oxide Electrolysis unit according to claim 1, wherein the Solid Oxide Electrolysis unit is configured such that the Solid Oxide Electrolysis cores and/or their upper housing can be lifted up by an external crane for maintenance and replacement of the Solid Oxide Electrolysis cores or stacks.

22. Solid Oxide Electrolysis unit according to claim 1, wherein the piping module/s and the power supply module/s are configured such that they can be preassembled before their installation onsite, wherein preferably the core module/s or the core frame/s with the Solid Oxide Electrolysis cores in combination with the intermediate module/s is/are also configured such that it/they can be preassembled before installation onsite.

23. Solid Oxide Electrolysis unit according to claim 1, wherein the headers in the piping module run an entire length of the piping module and are terminated at both ends with flanges or blind flanges.

24. Solid Oxide Electrolysis unit according to claim 1, wherein each one of the Solid Oxide Electrolysis cores has a capacity of at least 0.3 MW, preferably at least 0.5 MW.
